(19) United States
(12) Patent Application Publication
(10) Pub. No.: US 2010/0179944 A1
(43) Pub. Date: Jul. 15, 2010

(54) Local Data Retrieval And Restoration Method And System Thereof

(76) Inventors: Pankaj Anand, Haryana (IN); Nitin Arora, Haryana (IN); Puneet Trehan, Haryana (IN); Rakesh Sharrma, Haryana (IN); Aniruddha Chaudhuri, Cupertino, CA (US); Pankaj Sharma, Haryana (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/294,943

(22) PCT Filed: May 31, 2007
(86) PCT No.: PCT/IB2007/001421

§ 371 Date: Sep. 29, 2008

(30) Foreign Application Priority Data
May 31, 2006 (IN) 1317/DEL/2006

(51) Int. Cl. G06F 17/30

(52) U.S. Cl. 707/675; 707/E17.005

(57) ABSTRACT

The present invention provides a method and a system for retrieving and restoring data which is available on a local archival media but lost or not available at a computer terminal connectable to the said local archival media. A list of data available on a particular archival media and a list of data available at the computer terminal are compared and sorted appropriately to generate a list of lost data which are to be retrieved and restored from the local archival media. Once the list of lost data is generated, the list is checked to render the path and feasibility of retrieving and restoring the files. Finally, the files are retrieved by selecting path and location in computer terminal.

### FIELD OF THE INVENTION

The present invention relates to a system and a method for retrieving and restoring data which is available on a local archival media but lost or not available at a user terminal. More particularly, the present invention relates to a single click retrieval and restoration system that retrieves from a local archival media data or files that are newly created or changed or lost by a computer and stored on the local archival media data for the purpose of backup.

### BACKGROUND AND PRIOR ART DESCRIPTION

The process of taking backup of data stored on a computer is most commonly used in the present day in order to safeguard against loss of data due to various reasons. The process of retrieval and restoration is the process of obtaining from the backup location the data that has been lost. Thus, whenever, in the present application reference is made to recovery of lost data, it is intended to mean recovery of data which could be lost by any of the methods.

Typically a retrieval and restoration process requires the user to manually select a file/content for retrieval by searching it in the appropriate archival media where the backup was taken. This assumes the following:
1. The user is aware that he/she has lost some data.
2. The user is aware that he/she has some extra data on the archival media which is not present on his/her device.
3. The user is aware that he/she has a file/content, which is modified on the archival media, and the same needs to be modified on his/her device also.
4. The user is aware of the details of the archival media.
5. The user then selects list of content that he is interested in retrieving and then starts the retrieval process.

This process of retrieval is incomplete and cumbersome for the following reasons:
1. The user is sometimes not aware of loss of data. Accidental deletion, deletion of files by software makes it difficult for a user to know what has been lost or what data is available in the archival media that is not available in his computer device.
2. The user has to manually select what needs to be retrieved and restored by searching the archival media.
3. If the data that has been archived is huge, the archived data may have been stored in more than one archival media. In that case, there exists a possibility that more than one archival media would have contain more than one versions of the data. Thus it becomes very difficult for the user to determine the archival media from which a particular type of data must be archived.
4. This approach makes some of the loss go un-noticed and un-notified as a result the retrieval is not timely and incomplete.

### OBJECTS OF THE INVENTION

The main object of the present invention is a method and a system for retrieving and restoring the lost, new or changed data from computer that overcomes at least one of the drawbacks mentioned above or provides at least one additional benefit.

### SUMMARY OF THE INVENTION

Accordingly, the present invention provides a method and a system for retrieving and restoring data which is available on a local archival media but lost or not available at a computer terminal connectable to the said local archival media. A list of data available on a particular archival media and a list of data available at the computer terminal are compared and sorted appropriately to generate a list of lost data which are to be retrieved and restored from the local archival media. Once the list of lost data is generated, the list is checked to render the path and feasibility of retrieving and restoring the files. Finally, the files are retrieved by selecting path and location in computer terminal.

### DETAILED DESCRIPTION OF THE INVENTION

According to a first embodiment of the present invention, there is provided a method for retrieving and restoring data which is available on a local archival media but lost or not available at a computer terminal which is connectable to the local archival media, said method comprising:
(a) detecting deletion or corruption of data stored on the computer terminal;
(b) obtaining retrieval and restoration location from a parking list; wherein retrieval and restoration location comprises details of the local archival media, the complete path of directory or a file on the particular local archival media from where the data is going to be retrieved;
(c) prompting the user to connect the computer terminal to the local archival media comprising the data to be retrieved; and
(d) automatically retrieving and restoring the data that was deleted or corrupted on the computer terminal.

In an embodiment of the present invention, the method further comprises the step of receiving from a local archival media a list of the data stored thereupon on behalf of the computer terminal.

In another embodiment of the present invention, the step of detecting deletion or corruption of data stored on the computer terminal comprises:
(a) obtaining the details regarding at least one of the following (i) the watch location(s), (ii) watch data type(s) and (iii) category of the storage location(s);
(b) periodically keeping a watch on the watch location(s) for (a) deletion and/or corruption of data;
(c) preparing a deletion and/or corruption data list wherein the list comprises details of the data that have been detected as been deleted or corrupted on the computer terminal.

In still another embodiment, the present invention further comprises preparing a parking list based on the deletion and/or corruption data list.

In yet another embodiment of the present invention, if a watch file becomes corrupt or is missing or is mistakenly deleted, the user can restore a copy of it from the local archive media.

For this reason, it is important to ensure that the user archives the data regularly. The user can also restore older versions of files from a local archive. For example, if the user regularly archives a file, but want to revert to a previous version of a file, the user can do so by locating the file in the archive location. If the archive location is a local drive or network drive, the user can browse for the file. If the archive location is an external hard drive or USB drive, the user must connect the drive to the computer, and then browse for the file. If the archive location is a CD or DVD, the user must insert the CD or DVD in the computer, and then browse for the file.

Please note that the data from the media are automatically displayed in the deletion and/or corruption data list. This is based on two points . . . whether the latest version of the data on the computer is same as the media or the data has been deleted from the machine.

The user can also use Browse option to select a particular data from older archived versions incase the user needs multiple version of the same file.

The user can also restore files that have been archived on one computer from a different computer. For example, if the user archives a set of files to an external hard drive on computer A, he can restore those files on computer B. To do so, he must install Data Backup on computer B and connect the external hard drive. Then, in Data Backup, the user can browse for the files and they are added to the parking list for restoration.

### BRIEF DESCRIPTION OF THE ACCOMPANYING DRAWINGS

In order that the invention may be readily understood and put into practical effect, reference will now be made to exemplary embodiments as illustrated with reference to the accompanying drawings, where like reference numerals refer to identical or functionally similar elements throughout the separate views. The FIGURE together with a detailed description below, are incorporated in and form part of the specification, and serve to further illustrate the embodiments and explain various principles and advantages, in accordance with the present invention where:

FIG. 1 illustrates the flow chart of the method adopted for retrieving and restoring data which is available on a local archival media but lost or not available at a computer terminal.

The following paragraphs are provided in order to describe the working of the invention and nothing in this section should be taken as a limitation of the claims.

### DETAILED DESCRIPTION OF THE EMBODIMENTS

Before describing in detail embodiments that are in accordance with the present invention, it should be observed that the embodiments reside primarily in combinations of method steps of taking backup such that the backup procedure is faster, less bandwidth consuming and at the same time reliable.

Accordingly, the method steps have been represented where appropriate by conventional symbols in the drawings, showing only those specific details that are pertinent to understanding the embodiments of the present invention so as not to obscure the disclosure with details that will be readily apparent to those of ordinary skill in the art having benefit of the description herein.

The terms “comprises”, “comprising”, or any other variations thereof, are intended to cover a non-exclusive inclusion, such that a process, method that comprises a list of steps does not include only those steps but may include other steps not expressly listed or inherent to such process, method. An element proceeded by “comprises . . . a” does not, without more constraints, preclude the existence of additional identical steps in the process or method that comprises the steps.

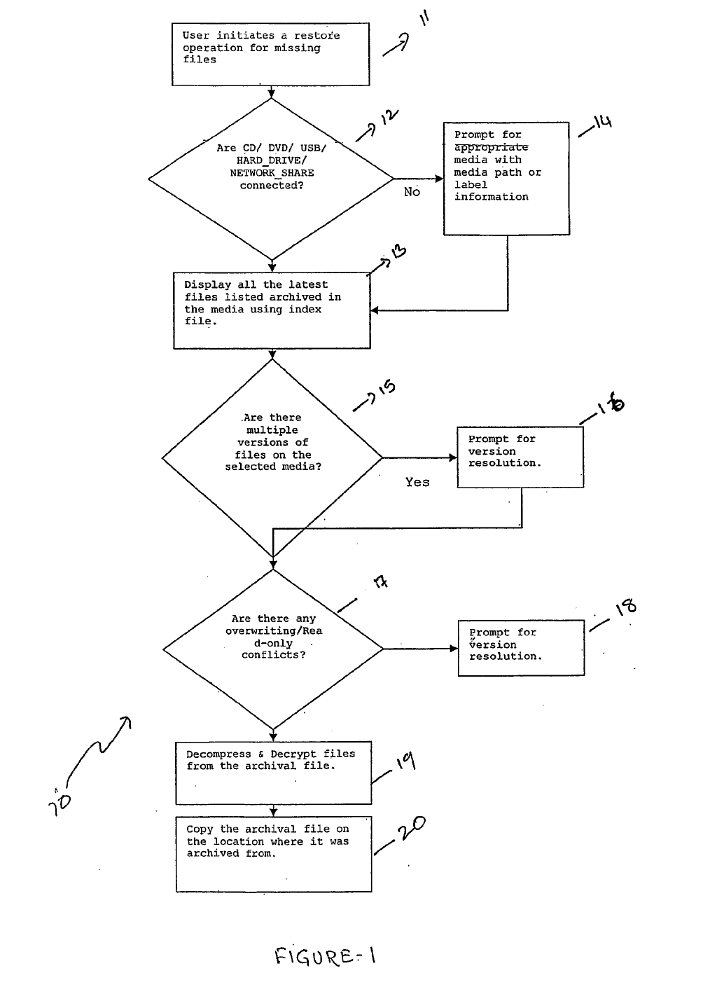

As can be noticed from FIG. 1, the process of retrieving and restoring data (10) which is available on a local archival media but lost or not available at a user terminal starts with the user initiating a restore operation for missing files (11). Once the process is initiated by the user, connection of storage medium upon which archived data is to be stored is checked and more particularly, connection of CD or DVD or USB or Hard Drive or Network Share is tested (12). If the storage medium is readily available, the latest files listed as achieved in the storage medium is displayed to the user using index file (13). On the other hand, if the storage medium is not connected or not available, then the user is prompted to connecting or loading the appropriate storage medium (14). Once the appropriate medium has been connected or loaded the method proceeds to step 13. After displaying the list of files contained on the storage medium, a check is performed to determine as to whether multiple versions of one or more files exist on the selected medium (15). If multiple versions of same file exist, then the user is prompted to determine as to the version which he would like to restore (16). Once the user has chosen the version or in case there does not exist multiple versions of same file, a check is performed to determine as to whether there would arise any overwriting and/or read-only conflicts during the process of restoration (17). In case it is determined that some overwriting and/or read-only conflict may arise during the step of restoration, the user is once again prompted to resolve the same in step 18. Once all the conflicts are addressed by the user or in case there does not arise any conflict, an archival file which is contained on the archival media is fetched, decompressed and decrypted to obtain the original file in step 19 and thereafter, the original file is stored at the location from where it was archived from in step 20.

The entire process is described by way of exemplification in the following paragraphs purely for the purpose of illustration.

### Restoration Process Flow

Master Index File: Application generated file during Full Archive containing all the Archival related information to restore the user data in its original state. This is binary serialized file having the following information.

Structure of this is as follow
1) ArchivalSetIndex Example: 1/4 ArchivalSet (This is first out of 4 CD burned in one session)
2) ArchivalSetName Example: 240507_{—}14-06-30F
3) ArchivalJob (For internal use)
4) FullRecurrencePattern (Full Archive Interval)
5) IncrementalRecurrencePattern (Quick Archive interval)
6) SourceLocation[ ](Array of all the locations that are under watch when archiving has been done)
7) DestinationLocation[ ] (Destination location on which archiving has been done)
8) ExclusionLocation[ ] (Excluded locations at the time of archiving)
9) EncryptionProvider (BlowFish etc)
10) EncryptionLevel
11) CompressionProvider (Sevenzip, zip etc)
12) ArchivalMedia (CD/DVD, HDD, network location)
13) Filter[ ] (Array of filters at the time of archiving)
14) ArchivalFiles (Collection of all the archival files which are archived in this collection)
15) IncrementalLocations (Array of all the incremental location)
16) ArchivalSetWriteTime (Exact time when archiving has been dome)
17) ArchivedLocation (Location at which archiving has been done)
18) ArchivalType (What type of archive is this Full, Incremental): In the current case it will be FULL

Incremental Index File: Application generated during Quick Archive file containing all the Archival related information to restore the user data in its original state.

Structure of this is as follow:
1) ArchivalSetIndex Example: 1/4 ArchivalSet (This is first out of 4 CD burned in one session)
2) ArchivalSetName Example: 240507_{—}14-06-30F
3) ArchivalJob (For internal use)
4) FullRecurrencePattern (Full Archive Interval)
5) IncrementalRecurrencePattern (Quick Archive interval)
6) SourceLocation[ ] (Array of all the locations that are under watch when archiving has been done)
7) DestinationLocation[ ] (Destination location on which archiving has been done)
8) ExclusionLocation[ ] (Excluded locations at the time of archiving)
9) EncryptionProvider (BlowFish etc)
10) EncryptionLevel
11) CompressionProvider (Sevenzip, zip etc)
12) ArchivalMedia (CD/DVD, HDD, network location)
13) Filter[ ] (Array of filters at the time of archiving)
14) ArchivalFiles (Collection of all the archival files which are archived in this collection)
15) IncrementalLocations (Array of all the incremental location)
16) ArchivalSetWriteTime (Exact time when archiving has been dome)
17) ArchivedLocation (Location at which archiving has been done)
18) ArchivalType (What type of archive is this Full, Incremental): In the current case it will be INCREMENTAL

Rendering of File: Example: File is archived from machine A location c:\Documents and Settings\User A\Desktop\abc.txt and now we are trying to restore on machine B. Then the client, path of this file is set according to machine B as c:\Documents and Settings\USer B\Desktop\abc.txt. This is called rendering of file.

Over-writable files: Files to be restored which are already present on machine on same path.

Writable files: Files which are not present on machine at same path+Overwritable files on which user has selected to overwritate the file which is present on machine.

Over-writable and Read-only Files: Files to be restored which are already present on machine on same path and having read-only attribute.

InValidMapwatch Location: watch locations that are not currently exist on current machine but present on machine on which files are originally archived.

Archival File: Entity which have information about the physical file which is passed on to PAE Engine.

Original Location: Location where files needs to be restored by restorer.

Restorer: Responsible for picking the archive from the destination location and restore and add the files to Archival List.

Pre-Restoration Manager: Responsible to create a separate list of compressed files and encrypted files.

ParkingResolver: Responsible for rendering of files and creating over-writable, writable, Invalid map Locations.

### Process Flow

1) User clicks on the Restore All or Restore button on the main UI.
2) If Restore All is clicked then all the files listed in missing file section are converted to object of Archival files and passed to Archival Agent. Else all the selected files in the missing file section are converted to object of Archival file and passed to Archival Agent.
3) Restoration or Selective Restoration command has started and UI is updated accordingly. Restore all button is converted to “Stop Restoration”.
4) Archival Agent created the object of PAEParkingResolver. PAEParkingResolver iterate through each file and Checks for following:
   1) Which files are already present at restoration location (Over writables files). Example: try to restore file to C:\Test\abc.txt but already file is present at c:\Test\abc.txt.
   2) Which files are already present at restoration location and have read only attribute. Example try to restore file to C:\Test\abc.txt but already file is present at c:\Test\abc.txt and abc.txt is read-only
   3) which locations which are not present on this machine. Example: trying of restoration from DVD which is archived from some other machine from D:\ drive but on the current machine D:\ Drive is not present.
   4) which files are actually not present on current machine and will be restored without any user action.
   5) which files are archived form the special folders. PAEParkinReolver renders the clientlocation of these files
   6) After Scanning all the files PAEParkingresolver returns Archival Agent following collections:
   1) Hashtable of locations that are not present on current machine (InValidmapLocation)
   2) Overwritable files.
   3) Overwritable and readonly files.
   4) Files which are not overwritable files (Writable files).
   5) Archival Agent checks for Mapwatch location and if there are any it displays Map watch location form. In this form user can Map the Invalid Maplocations to the some other valid locations.
   6) If there are some overwritable files then Archival Agent pass those files to the conflict panel. Conflict Panel displays all the files and user have 3 options to select “Skip” [Do not restore these files], “Overwrite” [Overwrite the file which is to be restored with the file that is present on disk], “Save As” [Save the files to some other location]
      a) If user selects “skip” for certain files those files will be removed from the overwritable files collections
      b) If user selects “save as” user can select different location for these files and these files will be added to the non-overwritable files collection.
      c) If the user select “Overwrite” then all of these files will remain in the overwritable file collection.
      1) Overwritable files collection is being added to the writable files
      2) else Archival Agent creates the object of Pre-RestorationManager and pass all the files which are non-overwritables to it.
   7) Prerestoration Manager iterates through each Archival file and checks that whether this file archive with compression or without compression.
   8) If the file is archived with compression then it is added into the collectin of compressed archive and if that file is archived with encryption or without Encryption or compression then it will be added to the separate collection.
   9) PreRestorationMgr also checks for size of 2 largest files. In case of with compression it will size of archive.
   10) ArchivalAgent takes the size of biggest files and check for space in windows drive. If the space is not available then it will display the TempDrive selectin form
   11) On TempDrive Selection form user can select different drive than windows drive for temporary work. (Decompression and decryption)
   12) Archival Agent creates the object of Restorer.
   13) Archival Agent checks the collection of Compressed file and if there are some files it will call the RestoreArchive function of Restorer.
      3) else Call the RetoreNow function of the Restorer.
   14) Restorer starts iterating through the collection of compressed Archive. It checks for server location of archive that whether archive exists at this path.
   15) If the archive does not exists at this path in it throws MediaNotFoundException.
   16) If it found the Archive at the required path then it creates the object of compression Agent and start decompressing the file at the temp location.
   17) Decompression occurs on archive by archive basis and then files are checked that whether decryption is required. If yes then decrypt the file on original location with .0 extension. File is created with .0 extensions because then watcher will not fire event for these files.
   18) Then rename the files to its original name.
   19) Restorer checks that whether files needs to added to ArchivalList. If yes then add the files and fire the event so that UI should display this file on Main UI.
   20) Restorer deletes all the temporary files from the temp location.
   21) After restoring the archive Archival Agent checks that whether it has something in no-compressed file collection. If No Then Finish Restoration command is called.
   22) Else Archival Agent calls the restorer with this non-compressed files and then restorer follow the steps 18, 19, 20.
   23) When restoration is completed then Archival Agent checks that whether there are some locations to be added under watch after restoration. If yes then it will add then.
   24) Scanning will be started automatically and then restoration operation will be completed successfully. Now the Stop Restoration will be changed back to Restore All.

We claim:

1. A method for retrieving and restoring data which is available on a local archival media but lost or not available at a computer terminal which is connectable to the local archival media, said method comprising:
a. detecting deletion or corruption of data stored on the computer terminal;
b. obtaining retrieval and restoration location from a parking list; wherein retrieval and restoration location comprises details of the local archival media, the complete path of directory or a file on the particular local archival media from where the data is going to be retrieved;
c. prompting the user to connect the computer terminal to the local archival media comprising the data to be retrieved; and
d. automatically retrieving and restoring the data that was deleted or corrupted on the computer terminal.

2. The method as claimed in claim 1, wherein the method further comprises the step of receiving from a local archival media a list of the data stored thereupon on behalf of the computer terminal.

3. The method as claimed in claim 1, wherein the step of detecting deletion or corruption of data stored on the computer terminal comprises:
a. obtaining the details regarding at least one of the following (i) the watch location(s), (ii) watch data type(s) and (iii) category of the storage location(s);
b. periodically keeping a watch on the watch location(s) for (a) deletion and/or corruption of data;
c. preparing a deletion and/or corruption data list wherein the list comprises details of the data that have been detected as been deleted or corrupted on the computer terminal.

4. The method as claimed in claim 1, wherein the method further comprises preparing a parking list based on the deletion and/or corruption data list.

5. The method as claimed in claim 1, wherein if a watch file becomes corrupt or is missing or is mistakenly deleted, the user is provided the option of restoring a copy of the same from the local archive media.
